(19) United States
(12) Patent Application Publication
(10) Pub. No.: US 2020/0247989 A1
(43) Pub. Date: Aug. 6, 2020

(54) POLYESTER AND FIBER

(71) Applicant: INDUSTRIAL TECHNOLOGY RESEARCH INSTITUTE, Hsinchu (TW)

(72) Inventors: Cheng-Jyun HUANG, Taoyuan City (TW); Chiou-Hwang LEE, Hsinchu City (TW); Guang-Way JANG, Hsinchu City (TW); Shu-Hua CHAN, Taichung City (TW); Shu-Chen LI, Hsinchu City (TW)

(73) Assignee: INDUSTRIAL TECHNOLOGY RESEARCH INSTITUTE, Hsinchu (TW)

(21) Appl. No.: 16/778,647

(22) Filed: Jan. 31, 2020

Related U.S. Application Data
(60) Provisional application No. 62/799,396, filed on Jan. 31, 2019.

(30) Foreign Application Priority Data
Nov. 28, 2019 (TW) 108143371

(51) Int. Cl. C08L 67/02; C08G 63/183

(52) U.S. Cl. CPC C08L 67/02; C08L 2203/12; C08G 63/183

(57) ABSTRACT

A polyester is provided, which is formed by copolymerizing (a) diacid or diester and (b) diol, wherein (a) diacid or diester includes (a1)

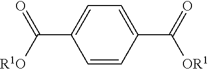

and (a2)

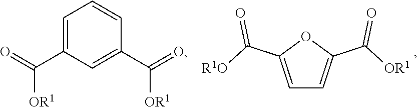

or a combination thereof, and each of R¹ is independently H or C₁₋₁₀ alkyl group, wherein (b) diol includes (b1) 1,6-hexanediol and (b2) 2,2,4,4-tetramethyl-1,3-cyclobutanediol, 1,4-cyclohexane dimethanol, tricyclo[5.2.1.0(2,6)]decanedimethanol, or a combination thereof, and (b1) 1,6-hexanediol and (b2) 2,2,4,4-tetramethyl-1,3-cyclobutanediol, 1,4-cyclohexane dimethanol, tricyclo[5.2.1.0(2,6)]decanedimethanol, or a combination thereof have a molar ratio (b1/b2) of 75:25 to 92:8.

### CROSS REFERENCE TO RELATED APPLICATIONS

This application claims the benefit of U.S. Provisional Application No. 62/799,396, filed on Jan. 31, 2019, the entirety of which is incorporated by reference herein. The present application is based on, and claims priority from, Taiwan Application Serial Number 108143371, filed Nov. 28, 2019, the disclosure of which is hereby incorporated by reference herein in its entirety.

### TECHNICAL FIELD

The technical field relates to polyester fibers, and relates to a composition and ratio of monomers for forming a polyester.

### BACKGROUND

Weaving a shoe vamp on a horizontal weaving machine requires a long fiber with a low melting point and enough fiber strength to withstand a high weaving speed and deliver a high production yield. The fiber that is shaped and cured by low-temperature hot melting may reduce the contraction ratio of the woven shoe vamp, which has excellent size stability to enhance the overall production yield of the product and lower the cost. Currently in use for producing woven shoe vamps are fibers with a low melting point (lower than 110° C.) and single-composition nylon long fibers, but the raw materials for the nylon having a low melting point is expensive and difficult to acquire.

Polyester material has been developed to serve as a fiber with a low melting point to overcome problems with nylon sourcing and difficulties in recycling woven shoe vamps, and to further increase the added value of the polyester material.

### SUMMARY

One embodiment of the disclosure provides a polyester, being formed by copolymerizing (a) diacid or diester and (b) diol, wherein (a) diacid or diester includes (a1) (which is

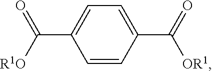

and each of R¹ is independently H or C₁₋₁₀ alkyl group) and (a2) (which is

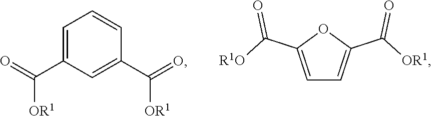

or a combination thereof, and each of R¹ is independently H or C₁₋₁₀ alkyl group), wherein (b) diol includes (b1) (which is 1,6-hexanediol) and (b2) (which is 2,2,4,4-tetramethyl-1,3-cyclobutanediol, 1,4-cyclohexane dimethanol, tricyclo[5.2.1.0(2,6)]decanedimethanol, or a combination thereof). (b1) and (b2) have a molar ratio (b1/b2) of 75:25 to 92:8.

In some embodiments, (a1) is

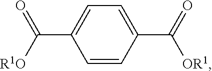

(a2) is

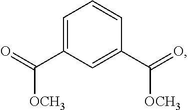 [SMILES: COC(=O)c1cccc(C(=O)OC)c1]

and (a1) and (a2)

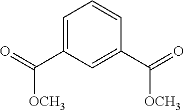 [SMILES: COC(=O)c1cccc(C(=O)OC)c1]

have a molar ratio (a1/a2) of 85:15 to 65:35.

In some embodiments, (a1) is

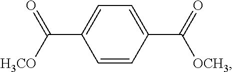 [SMILES: COC(=O)c1ccc(C(=O)OC)cc1]

(a2) is

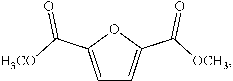 [SMILES: COC(=O)c1ccc(C(=O)OC)o1]

and (a1)

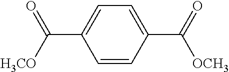 [SMILES: COC(=O)c1ccc(C(=O)OC)cc1]

and (a2)

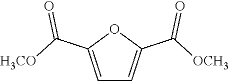 [SMILES: COC(=O)c1ccc(C(=O)OC)o1]

have a molar ratio (a1/a2) of 85:15 to 15:85.

In some embodiments, (b) diol is free of ethylene glycol.

In some embodiments, the polyester has a melting point of 80° C. to 115° C.

In some embodiments, the polyester has a glass transition temperature of 13° C. to 25° C.

In some embodiments, the polyester has an intrinsic viscosity of greater than 0.85 dL/g and less than 1.20 dL/g.

One embodiment of the disclosure provides a fiber, including the above polyester.

In some embodiments, the fiber has a fiber strength of greater than 0.9 gf/den and less than 5.0 gf/den.

In some embodiments, the fiber has a breaking elongation of greater than 10% and less than 200%.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a polyester, being formed by copolymerizing (a) diacid or diester and (b) diol, wherein (a) diacid or diester includes (a1) and (a2), wherein (a1) is

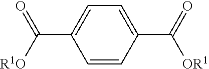

and (a2) is

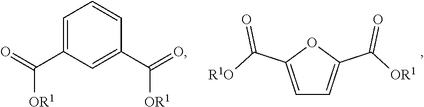

or a combination thereof, and each of R¹ is independently H or C₁₋₁₀ alkyl group. For example, R¹ can be H,

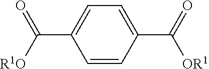

is terephthalic acid,

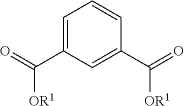

is isophthalic acid, and

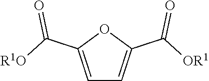

is 2,5-furandicarboxylic acid. Alternatively, R¹ can be methyl group,

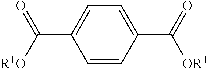

is dimethyl terephthalate (DMT),

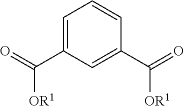

is dimethyl isophthalate (DMI), and

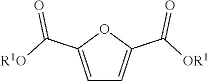

is dimethyl furan-2,5-dicarboxylate (DmFDCA). In addition, R¹ can be other alkyl group and not limited to the above examples.

One embodiment of the disclosure provides a polyester, being formed by copolymerizing (a) diacid or diester and (b) diol. (a) diacid or diester includes (a1)

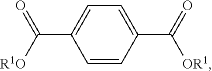

and (a2)

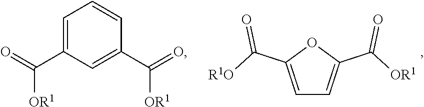

or a combination thereof, and each of R1 is independently H or C1-10 alkyl group. (b) diol comprises (b1) 1,6-hexanediol and (b2) 2,2,4,4-tetramethyl-1,3-cyclobutanediol, 1,4-cyclohexane dimethanol, tricyclo[5.2.1.0(2,6)]decanedimethanol, or a combination thereof, and wherein (b1) 1,6-hexanediol and (b2) 2,2,4,4-tetramethyl-1,3-cyclobutanediol, 1,4-cyclohexane dimethanol, tricyclo[5.2.1.0(2,6)]decanedimethanol, or a combination thereof have a molar ratio (b1/b2) of 75:25 to 92:8.

On the other hand, (b) diol includes (b1) and (b2), wherein (b 1) is 1,6-hexanediol and (b2) is 2,2,4,4-tetramethyl-1,3-cyclobutanediol (CBDO), 1,4-cyclohexane dimethanol, tricyclo[5.2.1.0(2,6)]decanedimethanol, or a combination thereof. The molar ratio (b1/b2) of (b1) and (b2) is from 75:25 to 92:8, such as 80:20 to 91:9, or 85:15 to 90:10. If (b1) 1,6-hexanediol is too much, the glass transition temperature (Tg) of the polyester will be too low, the woven object after being thermally shaped will be too soft, and the melting point of the polyester will be too high to satisfy the need for a melting point lower than 110° C. If (b1) 1,6-hexanediol is too less, the crystallinity of the material will be decreased, the spinning will be not easy, and the strength of the fiber will be low.

In one embodiment, (a1) is

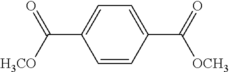 [SMILES: COC(=O)c1ccc(C(=O)OC)cc1]

and (a2) is

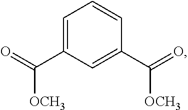 [SMILES: COC(=O)c1cccc(C(=O)OC)c1]

and the molar ratio (a1/a2) is from 85:15 to 65:35, such as 80:20 to 70:30. If (a1) DMT is too much, the melting point of the polyester cannot be lowered to be less than or equal to 110° C. If (a1) DMT is too less, the crystallinity of the material will be too low, the polyester cannot be easily spun, and the strength of the fiber will be low.

In one embodiment, (a1) is

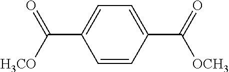 [SMILES: COC(=O)c1ccc(C(=O)OC)cc1]

and (a2) is

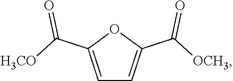 [SMILES: COC(=O)c1ccc(C(=O)OC)o1]

and the molar ratio (a1/a2) is from 80:20 to 20:80. If (a1) DMT is too much, the melting point of the polyester cannot be lowered to be less than or equal to 110° C. If (a1) DMT is too less, the crystallinity of the material will be too low, the polyester cannot be easily spun, and the strength of the fiber will be low.

Note that (b) diol is free of ethylene glycol. If (b) diol contains ethylene glycol (the common monomer usually used in polyester), the melting point of the polyester will be too high, and the Tg of the polyester will be too low.

In one embodiment, appropriate ratio of (a) diacid or diester, (b) diol, and zinc acetate (catalyst) are mixed. Nitrogen is introduced, and the mixture is heated to 190° C. to 200° C. for transesterification. After 2 hours to 3 hours of the transesterification, thermal stabilizer (phosphoric acid) and titanium catalyst are added to perform the condensation polymerization. The pressure of the reaction system is gradually reduced to 5 torr to 100 torr to remove the excess 1,6-hexanediol monomer. The reaction temperature is gradually heated to 270° C. to 280° C., the reaction pressure is then gradually reduced to less than or equal to 1 torr, and the reaction is continued for 120 minutes to 180 minutes. Finally, the vacuum is broken by introducing nitrogen, heating and stirring are stopped, and polyester product is obtained. In one embodiment, the polyester has a melting point of 80° C. to 115° C. If the melting point of the polyester is too high, the thermal shaping temperature for the woven object will be too high, and the yarn will be difficult to be hot-melted by steam to strengthen the woven object structure, and the woven object size will contract at high temperature condition. If the melting point of the polyester is too low, the woven object will be easily deformed by heat. In one embodiment, the polyester has Tg of 13° C. to 25° C. If Tg of the polyester is too high, the woven object will lack softness and comfortability. If Tg of the polyester is too low, the stiffness of the woven object will be not excellent, and shoe vamp will easily deform. In one embodiment, the polyester has an intrinsic viscosity of greater than 0.85 dL/g and less than 1.20 dL/g, such as greater than 0.9 dL/g and less than 1.20 dL/g. If the intrinsic viscosity of the polyester is too high, the hot melted polyester will have poor flowability and low adhesion. If the intrinsic viscosity of the polyester is too low, the polyester will not be easily spun, the filament will be easily broken, and the hot melting spinning yield will be not excellent. The polyester is spun at a spinning temperature of 200° C. to 250° C. and a spinning rate of 1,000 meters/minute to 3,000 meters/minute to form a yarn containing 24 fibers (so-called polyester fiber). The polyester fiber is post-stretched at 40° C. to 60° C. at a stretching ratio of 1.1 to 1.6 for fully stretching the polyester fiber. In one embodiment, the fiber strength of the fiber is greater than 0.9 gf/den and less than 5.0 gf/den, such as greater than 0.9 gf/den and less than 4.0 gf/den, or greater than 0.9 gf/den and less than 3.0 gf/den. If the fiber strength of the fiber is too low, the filament will be easily broken during weaving the shoe vamp. In one embodiment, the fiber has a breaking elongation of greater than 10% and less than 200%, such as greater than 10% and less than 150%. If the breaking elongation of the fiber is too low, the stretchability of the fiber will be low, and the filament will be easily broken.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

300 g of DMT (1.545 mol), 75 g of DMI (0.386 mol), 34.8 g of CBDO (0.241 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DMI had a molar ratio of 80:20. The ratio of the diols for being copolymerized the polyester was determined by NMR, in which 1,6-hexanediol and CBDO had a molar ratio of 90:10. The polyester had an intrinsic viscosity of greater than 0.971 dL/g (measured by the standard ASTM D4603-2003), a melting point of 111.3° C. (measured by the standard ASTM D3418-15), a glass transition temperature of 14.7° C. (measured by the standard ASTM D3418-15), and a crystallinity of 20.3 J/g (measured by the standard ASTM D3418-15). The polyester was spun at a spinning temperature of 220° C. and a spinning rate of 1,000 meter/minute to obtain a yarn containing 24 fibers (so-called polyester fiber). The polyester fiber was post-stretched at 45° C. and a stretching ratio of 1.4 to fully stretch the polyester fiber. The fiber before stretching had a fiber strength of 1.55 gf/den (measured by the standard ASTM D3822-2007) and a breaking elongation of 134.2% (measured by the standard ASTM D3822-2007). The fully stretched fiber had a fiber strength of 2.23 gf/den (measured by the standard ASTM D3822-2007) and a breaking elongation of 47.1% (measured by the standard ASTM D3822-2007).

### Example 2

300 g of DMT (1.545 mol), 75 g of DMI (0.386 mol), 41.7 g of CBDO (0.29 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DMI had a molar ratio of 80:20. The ratio of the diols for being copolymerized the polyester was determined by NMR, in which 1,6-hexanediol and CBDO had a molar ratio of 87:13. The polyester had an intrinsic viscosity of greater than 0.960 dL/g (measured by the standard ASTM D4603-2003), a melting point of 107.5° C. (measured by the standard ASTM D3418-15), a glass transition temperature of 15.4° C. (measured by the standard ASTM D3418-15), and a crystallinity of 18.9 J/g (measured by the standard ASTM D3418-15). The polyester was spun at a spinning temperature of 220° C. and a spinning rate of 1,000 meter/minute to obtain a yarn containing 24 fibers (so-called polyester fiber). The fiber had a fiber strength of 2.20 gf/den (measured by the standard ASTM D3822-2007) and a breaking elongation of 59.1% (measured by the standard ASTM D3822-2007). In this example, the fiber strength could achieve 2.0 gf/den without the post-stretching process.

### Example 3

75 g of DMT (0.386 mol), 284.3 g of DmFDCA (1.545 mol), 55.6 g of CBDO (0.386 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DmFDCA had a molar ratio of 20:80. The ratio of the diols for being copolymerized the polyester was determined by NMR, in which 1,6-hexanediol and CBDO had a molar ratio of 85:15. The polyester had an intrinsic viscosity of greater than 0.940 dL/g (measured by the standard ASTM D4603-2003), a melting point of 106.7° C. (measured by the standard ASTM D3418-15), a glass transition temperature of 17.6° C. (measured by the standard ASTM D3418-15), and a crystallinity of 23.9 J/g (measured by the standard ASTM D3418-15). The polyester was spun at a spinning temperature of 220° C. and a spinning rate of 1,000 meter/minute to obtain a yarn containing 24 fibers (so-called polyester fiber). The polyester fiber was post-stretched at 45° C. and a stretching ratio of 1.4 to fully stretch the polyester fiber. The fiber before stretching had a fiber strength of 0.92 gf/den (measured by the standard ASTM D3822-2007) and a breaking elongation of 147.4% (measured by the standard ASTM D3822-2007). The fully stretched fiber had a fiber strength of 1.50 gf/den (measured by the standard ASTM D3822-2007) and a breaking elongation of 32.3% (measured by the standard ASTM D3822-2007).

### Example 4

300 g of DMT (1.545 mol), 75 g of DMI (0.386 mol), 41.8 g of 1,4-cyclohexane dimethanol (CHDM, 0.29 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DMI had a molar ratio of 80:20. The ratio of the diols for being copolymerized the polyester was determined by NMR, in which 1,6-hexanediol and CHDM had a molar ratio of 85:15. The polyester had an intrinsic viscosity of greater than 0.993 dL/g (measured by the standard ASTM D4603-2003), a melting point of 112.8 ° C. (measured by the standard ASTM D3418-15), a glass transition temperature of 16.6° C. (measured by the standard ASTM D3418-15), and a crystallinity of 22.0 J/g (measured by the standard ASTM D3418-15). The polyester was spun at a spinning temperature of 230° C. and a spinning rate of 1,000 meter/minute to obtain a yarn containing 24 fibers (so-called polyester fiber). The polyester fiber was post-stretched at 45° C. and a stretching ratio of 1.45 to fully stretch the polyester fiber. The fiber before stretching had a fiber strength of 2.0 gf/den (measured by the standard ASTM D3822-2007) and a breaking elongation of 71.2% (measured by the standard ASTM D3822-2007). The fully stretched fiber had a fiber strength of 3.7 gf/den (measured by the standard ASTM D3822-2007) and a breaking elongation of 21% (measured by the standard ASTM D3822-2007).

### Example 5

300 g of DMT (1.545 mol), 75 g of DMI (0.386 mol), 37.9 g of Tricyclo[5.2.1.0(2,6)]decanedimethanol (TDD, 0.193 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DMI had a molar ratio of 80:20. The ratio of the diols for being copolymerized the polyester was determined by NMR, in which 1,6-hexanediol and TDD had a molar ratio of 90:10. The polyester had an intrinsic viscosity of greater than 0.925 dL/g (measured by the standard ASTM D4603-2003), a melting point of 105.7° C. (measured by the standard ASTM D3418-15), a glass transition temperature of 17.1 ° C. (measured by the standard ASTM D3418-15), and a crystallinity of 19.3 J/g (measured by the standard ASTM D3418-15). The polyester was spun at a spinning temperature of 220° C. and a spinning rate of 1,000 meter/minute to obtain a yarn containing 24 fibers (so-called polyester fiber). The polyester fiber was post-stretched at 45° C. and a stretching ratio of 1.45 to fully stretch the polyester fiber. The fiber before stretching had a fiber strength of 2.4 gf/den (measured by the standard ASTM D3822-2007) and a breaking elongation of 75.5% (measured by the standard ASTM D3822-2007). The fully stretched fiber had a fiber strength of 3.2 gf/den (measured by the standard ASTM D3822-2007) and a breaking elongation of 20% (measured by the standard ASTM D3822-2007).

### Example 6

263 g of DMT (1.351 mol), 112 g of DMI (0.579 mol), 41.8 g of CHDM (0.29 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DMI had a molar ratio of 70:30. The ratio of the diols for being copolymerized the polyester was determined by NMR, in which 1,6-hexanediol and CHDM had a molar ratio of 85:15. The polyester had an intrinsic viscosity of greater than 0.988 dL/g (measured by the standard ASTM D4603-2003), a melting point of 96.5° C. (measured by the standard ASTM D3418-15), a glass transition temperature of 15.7° C. (measured by the standard ASTM D3418-15), and a crystallinity of 17.8 J/g (measured by the standard ASTM D3418-15). The polyester was spun at a spinning temperature of 230° C. and a spinning rate of 1,000 meter/minute to obtain a yarn containing 24 fibers (so-called polyester fiber). The polyester fiber was post-stretched at 45° C. and a stretching ratio of 1.4 to fully stretch the polyester fiber. The fiber before stretching had a fiber strength of 1.86 gf/den (measured by the standard ASTM D3822-2007) and a breaking elongation of 85.3% (measured by the standard ASTM D3822-2007). The fully stretched fiber had a fiber strength of 2.8 gf/den (measured by the standard ASTM D3822-2007) and a breaking elongation of 26.3% (measured by the standard ASTM D3822-2007).

The monomer ratios and the fiber properties of the polyesters in Examples 1 to 6 are shown in Table 1. As known from Examples 1 to 6, appropriate cyclic diol monomer could make the polyester have a melting point lower than 115° C., a certain degree of crystallinity, and a intrinsic viscosity greater than 0.9 dL/g. In addition, the Tg of the polyester increased as the cyclic diol amount increased. The polyesters in Examples 1 to 6 were spun well, and their properties were similar to those of a nylon fiber having a low melting point.

TABLE 1

| | | Example 1 | Example 2 | Example 3 | Example 4 | Example 5 | Example 6 |
|---|---|---|---|---|---|---|---|
| diester (mol %) | DMT | 80 | 80 | 20 | 80 | 80 | 70 |
| | DMI | 20 | 20 | 0 | 20 | 20 | 30 |
| | DmFDCA | 0 | 0 | 80 | 0 | 0 | 0 |
| diol (mol %) | 1,6-hexanediol | 90 | 87 | 85 | 85 | 90 | 85 |
| | CBDO | 10 | 13 | 15 | 0 | 0 | 0 |
| | CHDM | 0 | 0 | 0 | 15 | 0 | 15 |
| | TDD | 0 | 0 | 0 | 0 | 10 | 0 |
| | intrinsic viscosity | 0.971 | 0.960 | 0.940 | 0.993 | 0.925 | 0.988 |
| | (dL/g) | | | | | | |
| | melting point | 111.3 | 107.5 | 106.7 | 112.8 | 105.7 | 96.5 |
| | (° C.) | | | | | | |
| | Tg (° C.) | 14.7 | 15.4 | 17.6 | 16.6 | 17.1 | 15.7 |
| | crystallinity (J/g) | 20.3 | 18.9 | 23.9 | 22.0 | 19.3 | 17.8 |
| Fiber before | fiber strength | 1.55 | 2.20 | 0.92 | 2.0 | 2.4 | 1.86 |
| stretching | (gf/den) | | | | | | |
| | Breaking | 134.2 | 59.1 | 147.4 | 71.2 | 75.5 | 85.3 |
| | elongation (%) | | | | | | |
| Fiber after | Fiber strength | 2.23 | NA | 1.50 | 3.7 | 3.2 | 2.8 |
| stretching | Breaking | 47.1 | NA | 32.3 | 21 | 20 | 26.3 |
| | elongation (%) | | | | | | |

### Comparative Example 1

300 g of DMT (1.545 mol), 71 g of DmFDCA (0.386 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DMI had a molar ratio of 80:20. The polyester had an intrinsic viscosity of greater than 0.80 dL/g (measured by the standard ASTM D4603-2003), a melting point of 125° C. (measured by the standard ASTM D3418-15), a glass transition temperature of 7.5° C. (measured by the standard ASTM D3418-15), and a crystallinity of 29.2 J/g (measured by the standard ASTM D3418-15). The melting point of the polyester was too high, such that the polyester was not suitable for being thermally shaped at low temperature. The Tg of the polyester is too low, such that the polyester was not suitable for being spun. The yarns after spinning and winding had a poor stability, and the yarns were sticky. As such, the strength and elongation of the polyester fiber could not be analyzed.

### Comparative Example 2

75 g of DMT (0.386 mol), 284.3 g of DmFDCA (1.545 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DmFDCA had a molar ratio of 20:80. The polyester had an intrinsic viscosity of greater than 0.81 dL/g (measured by the standard ASTM D4603-2003), a melting point of 126.2° C. (measured by the standard ASTM D3418-15), a glass transition temperature of 10.2° C. (measured by the standard ASTM D3418-15), and a crystallinity of 33.7 J/g (measured by the standard ASTM D3418-15). The melting point of the polyester was too high, such that the polyester was not suitable for being thermally shaped at low temperature. The polyester was not suitable for being spun. The yarns after spinning and winding had a poor stability, and the yarns were sticky. As such, the strength and elongation of the polyester fiber could not be analyzed.

### Comparative Example 3

300 g of DMT (1.545 mol), 75 g of DMI (0.386 mol), 25.9 g of ethylene glycol (EG, 0.405 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DMI had a molar ratio of 80:20. The ratio of the diols for being copolymerized the polyester was determined by NMR, in which 1,6-hexanediol and EG had a molar ratio of 85:15. The polyester had an intrinsic viscosity of greater than 0.950 dL/g (measured by the standard ASTM D4603-2003), a melting point of 118.1° C. (measured by the standard ASTM D3418-15), a glass transition temperature of 10.2° C. (measured by the standard ASTM D3418-15), and a crystallinity of 23.8 J/g (measured by the standard ASTM D3418-15). The polyester was spun at a spinning temperature of 220° C. and a spinning rate of 1,000 meter/minute to obtain a yarn containing 24 fibers (so-called polyester fiber). The polyester fiber was post-stretched at 45° C. and a stretching ratio of 1.5 to fully stretch the polyester fiber. The fiber before stretching had a fiber strength of 2.42 gf/den (measured by the standard ASTM D3822-2007) and a breaking elongation of 92.6% (measured by the standard ASTM D3822-2007). The fully stretched fiber had a fiber strength of 3.28 gf/den (measured by the standard ASTM D3822-2007) and a breaking elongation of 28.3% (measured by the standard ASTM D3822-2007). Because the diols for being copolymerized to form the polyester included EG rather than the suitable cyclic diol, the Tg of the polyester would be too low (e.g. if being applied to woven vamp in shoes, the stiffness of the vamp would be low and easily deformed) and the melting point would be too high (e.g. the steam shaping cost time and energy).

### Comparative Example 4

300 g of DMT (1.545 mol), 75 g of DMI (0.386 mol), 28.2 g of isosorbide (0.193 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DMI had a molar ratio of 80:20. The ratio of the diols for being copolymerized the polyester was determined by NMR, in which 1,6-hexanediol and isosorbide had a molar ratio of 99:1. The polyester had an intrinsic viscosity of greater than 0.958 dL/g (measured by the standard ASTM D4603-2003), a melting point of 120.4° C. (measured by the standard ASTM D3418-15), a glass transition temperature of 9.3° C. (measured by the standard ASTM D3418-15), and a crystallinity of 22.4 J/g (measured by the standard ASTM D3418-15). Because the reactivity of isosorbide was not good, the Tg of the polyester is too low, the yarns after spinning and winding had a poor stability, and the yarns were sticky. The polyester was not suitable for forming a fiber of high strength. As such, the strength and elongation of the polyester fiber could not be analyzed.

### Comparative Example 5

300 g of DMT (1.545 mol), 75 g of DMI (0.386 mol), 92.8 g of hydrogenated bisphenol A (HBPA, 0.386 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DMI had a molar ratio of 80:20. The ratio of the diols for being copolymerized the polyester was determined by NMR, in which 1,6-hexanediol and HBPA had a molar ratio of 80:20. The polyester had an intrinsic viscosity of greater than 0.529 dL/g (measured by the standard ASTM D4603-2003), a melting point of 108.3 ° C. (measured by the standard ASTM D3418-15), a glass transition temperature of 20.2° C. (measured by the standard ASTM D3418-15), and a crystallinity of 22.6 J/g (measured by the standard ASTM D3418-15). Because the thermal stability of the HBPA was poor, the HBPA would thermal degrade during the process of high temperature polymerization at 280° C. for enhancing intrinsic viscosity. The intrinsic viscosity of the polyester was firstly increased and then decreased, such that intrinsic viscosity of the polyester would be too low to be spun for forming a fiber of high strength.

### Comparative Example 6

300 g of DMT (1.545 mol), 75 g of DMI (0.386 mol), 19.1 g of 4,4′-bicyclohexanol (0.0965 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DMI had a molar ratio of 80:20. The ratio of the diols for being copolymerized the polyester was determined by NMR, in which 1,6-hexanediol and 4,4′-bicyclohexanol had a molar ratio of 96:4. The polyester had an intrinsic viscosity of greater than 0.905 dL/g (measured by the standard ASTM D4603-2003), a melting point of 120.0 ° C. (measured by the standard ASTM D3418-15), a glass transition temperature of 15.8° C. (measured by the standard ASTM D3418-15), and a crystallinity of 24.4 J/g (measured by the standard ASTM D3418-15). The polyester was spun at a spinning temperature of 220° C. and a spinning rate of 1,000 meter/minute to obtain a yarn containing 24 fibers (so-called polyester fiber). The polyester fiber was post-stretched at 45° C. and a stretching ratio of 1.4 to fully stretch the polyester fiber. The fiber before stretching had a fiber strength of 2.0 gf/den (measured by the standard ASTM D3822-2007) and a breaking elongation of 65% (measured by the standard ASTM D3822-2007). The fully stretched fiber had a fiber strength of 2.6 gf/den (measured by the standard ASTM D3822-2007) and a breaking elongation of 25.1% (measured by the standard ASTM D3822-2007). Because the diols for being copolymerized to form the polyester included 4,4′-bicyclohexanol rather than the suitable cyclic diol, the melting point of the polyester would be reduced a little. 4,4′-bicyclohexanol had a rigid structure and poor reactivity. If 4,4′-bicyclohexanol ratio was increased, it would be difficult to enhance the viscosity of the polyester over 0.90 dL/g. Accordingly, not all cyclic diol is suitable for matching 1,6-hexanediol to form the polyester of low melting point and high strength.

### Comparative Example 7

300 g of DMT (1.545 mol), 75 g of DMI (0.386 mol), 62 g of 3,9-bis(1,1-dimethyl-2-hydroxyethyl)-2,4,8,10-tetraoxaspiro[5.5]undecane (SPG, 0.204 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DMI had a molar ratio of 80:20. The ratio of the diols for being copolymerized the polyester was determined by NMR, in which 1,6-hexanediol and SPG had a molar ratio of 90:10. The polyester had an intrinsic viscosity of greater than 0.659 dL/g (measured by the standard ASTM D4603-2003), a melting point of 115.7° C. (measured by the standard ASTM D3418-15), a glass transition temperature of 10.4° C. (measured by the standard ASTM D3418-15), and a crystallinity of 30.2 J/g (measured by the standard ASTM D3418-15). The polyester was spun at a spinning temperature of 220° C. and a spinning rate of 1,000 meter/minute to obtain a yarn containing 24 fibers (so-called polyester fiber). The fiber had a fiber strength of 1.14 gf/den (measured by the standard ASTM D3822-2007) and a breaking elongation of 20.5% (measured by the standard ASTM D3822-2007). The breaking elongation of the fiber was too low to be stretched, which might be resulted from the partial crosslinking of SPG during polymerization.

### Comparative Example 8

79.1 g of DMT (0.408 mol), 300 g of DmFDCA (1.63 mol), 62 g of SPG (0.204 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DmFDCA had a molar ratio of 20:80. The ratio of the diols for being copolymerized the polyester was determined by NMR, in which 1,6-hexanediol and SPG had a molar ratio of 90:10. The polyester had an intrinsic viscosity of greater than 0.744 dL/g (measured by the standard ASTM D4603-2003), a melting point of 108.5° C. (measured by the standard ASTM D3418-15), a glass transition temperature of 19.4° C. (measured by the standard ASTM D3418-15), and a crystallinity of 24.5 J/g (measured by the standard ASTM D3418-15). The polyester was spun at a spinning temperature of 220° C. and a spinning rate of 1,000 meter/minute to obtain a yarn containing 24 fibers (so-called polyester fiber). The polyester fiber was post-stretched at 45° C. and a stretching ratio of 1.3 to fully stretch the polyester fiber. The fiber before stretching had a fiber strength of 1.10 gf/den (measured by the standard ASTM D3822-2007) and a breaking elongation of 81.2% (measured by the standard ASTM D3822-2007). The fully stretched fiber had a fiber strength of 1.87 gf/den (measured by the standard ASTM D3822-2007) and a breaking elongation of 7.80% (measured by the standard ASTM D3822-2007). The breaking elongation of the fiber after being stretched was too low, which might be resulted from the partial crosslinking of SPG during polymerization.

### Comparative Example 9

225 g of DMT (1.158 mol), 150 g of DMI (0.772 mol), 41.8 g of CHDM (0.29 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DMI had a molar ratio of 60:40. The ratio of the diols for being copolymerized the polyester was determined by NMR, in which 1,6-hexanediol and CHDM had a molar ratio of 85:15. The polyester had an intrinsic viscosity of greater than 0.950 dL/g (measured by the standard ASTM D4603-2003), no melting point that could be measured (measured by the standard ASTM D3418-15), a glass transition temperature of 15.1° C. (measured by the standard ASTM D3418-15), and no crystallinity that could be measured due to its amorphous state (measured by the standard ASTM D3418-15). The polyester cannot be spun due to its amorphous state.

### Comparative Example 10

300 g of DMT (1.545 mol), 75 g of DMI (0.386 mol), 27.8 g of CBDO (0.193 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 180 minutes. Finally, the vacuum was broken by nitrogen, heating and stirring were stopped, and polyester product was obtained. The ratio of the diesters for being copolymerized the polyester was determined by NMR, in which DMT and DMI had a molar ratio of 80:20. The ratio of the diols for being copolymerized the polyester was determined by NMR, in which 1,6-hexanediol and CBDO had a molar ratio of 92.5:7.5. The polyester had an intrinsic viscosity of greater than 0.996 dL/g (measured by the standard ASTM D4603-2003), a melting point of 116.7° C. (measured by the standard ASTM D3418-15), a glass transition temperature of 11.4° C. (measured by the standard ASTM D3418-15), and a crystallinity of 31.0 J/g (measured by the standard ASTM D3418-15). The polyester was spun at a spinning temperature of 220° C. and a spinning rate of 1,000 meter/minute to obtain a yarn containing 24 fibers (so-called polyester fiber). The polyester fiber was post-stretched at 45° C. and a stretching ratio of 1.4 to fully stretch the polyester fiber. The fiber before stretching had a fiber strength of 1.34 gf/den (measured by the standard ASTM D3822-2007) and a breaking elongation of 145.1% (measured by the standard ASTM D3822-2007). The fully stretched fiber had a fiber strength of 2.31 gf/den (measured by the standard ASTM D3822-2007) and a breaking elongation of 19% (measured by the standard ASTM D3822-2007). The composition could obtain a fiber material with strength higher than 2.0 gf/den, but its melting point was higher than 115° C. and its Tg is lower than 13° C.

### Comparative Example 11

75 g of DMT (0.386 mol), 284.3 g of DmFDCA (1.545 mol), 27.8 g of CBDO (0.193 mol), 320 g of 1,6-hexanediol (2.7 mol), and 200 ppm of zinc acetate (based on the theoretical weight of product) were added into a reaction tank. Nitrogen was introduced into the reaction tank, and the mixture in the reaction tank was heated to 200° C. and stirred at 150 rpm to perform transesterification. After 3 hours of the transesterification, the condensed methanol was removed, and 0.055 g of thermal stabilizer (phosphoric acid having the same moles as the zinc acetate) and 0.0778 g of titanium catalyst C-94 (150 ppm, based on the theoretical weight of product) were added to the reaction tank. The pressure of the reaction system was gradually reduced to 50 torr in 30 minutes to remove the excess 1,6-hexanediol monomer. The reaction temperature was gradually heated to 280° C., the reaction pressure was gradually reduced to less than or equal to 1 torr, and the reaction was continued for 120 minutes. Finally, the vacuum was broken by nitrogen, heating and stirring were stopped, and polyester product was obtained. The ratio of the diesters for being copolymerized the polyester was determined by NMR, in which DMT and DmFDCA had a molar ratio of 20:80. The ratio of the diols for being copolymerized the polyester was determined by NMR, in which 1,6-hexanediol and CBDO had a molar ratio of 92.5:7.5. The polyester had an intrinsic viscosity of greater than 0.959 dL/g (measured by the standard ASTM D4603-2003), a melting point of 117.1° C. (measured by the standard ASTM D3418-15), a glass transition temperature of 14.3° C. (measured by the standard ASTM D3418-15), and a crystallinity of 30.1 J/g (measured by the standard ASTM D3418-15). The polyester was spun at a spinning temperature of 220° C. and a spinning rate of 1,000 meter/minute to obtain a yarn containing 24 fibers (so-called polyester fiber). The composition was spun to form the fiber that is relaxed during the step of collecting yarn tubes, and the properties of the fiber could not be measured well. In addition, the fiber could not be post-stretched.

TABLE 2

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| diester | DMT | 80 | 20 | 80 | 80 | | |
| (mol %) | DMI | 0 | | 20 | 20 | | |
| | DmFDCA | 20 | 80 | 0 | 0 | | |
| diol | 1,6-hexanediol | 100 | | 85 | 99 | 80 | 96 |
| (mol %) | EG | 0 | | 15 | 0 | | |
| | CBDO | 0 | | | | | |
| | isosorbide | 0 | | | 1 | 0 | 0 |
| | HBPA | 0 | | | 0 | 20 | 0 |
| | 4,4′- | 0 | | | 0 | 0 | 4 |
| | bicyclohexanol | | | | | | |
| | SPG | 0 | | | | | |
| | CHDM | 0 | | | | | |
| | intrinsic viscosity | 0.80 | 0.81 | 0.950 | 0.958 | 0.529 | 0.905 |
| | (dL/g) | | | | | | |
| | melting point | 125 | 126.2 | 118.1 | 120.4 | 108.3 | 120.0 |
| | (° C.) | | | | | | |
| | Tg (° C.) | 7.5 | 10.2 | 10.2 | 9.3 | 20.2 | 15.8 |
| | crystallinity (J/g) | 29.2 | 33.7 | 23.8 | 22.4 | 22.6 | 24.4 |
| fiber | fiber strength | NA | NA | 2.42 | NA | NA | 2.0 |
| before | (gf/den) | | | | | | |
| stretching | breaking | NA | NA | 92.6 | NA | NA | 65.3 |
| | elongation (%) | | | | | | |
| fiber | fiber strength | NA | NA | 3.28 | NA | NA | 2.6 |
| after | breaking | NA | NA | 28.3 | NA | NA | 25.1 |
| stretching | elongation (%) | | | | | | |

TABLE 3

| | | Comparative | Comparative | Comparative | Comparative | Comparative |
|---|---|---|---|---|---|---|
| | | Example 7 | Example 8 | Example 9 | Example 10 | Example 11 |
| diester | DMT | 80 | 20 | 60 | 80 | 20 |
| (mol %) | DMI | 20 | 0 | 40 | 20 | 0 |
| | DmFDCA | 0 | 80 | 0 | 0 | 80 |
| diol (mol %) | 1,6-hexanediol | 90 | | 85 | 92.5 | |
| | EG | 0 | | 0 | 0 | |
| | CBDO | 0 | | | 7.5 | |
| | isosorbide | 0 | | | | |
| | HBPA | 0 | | | | |
| | 4,4′-bicyclohexanol | 0 | | | | |
| | SPG | 10 | | 0 | | |
| | CHDM | 0 | | 15 | 0 | |
| | intrinsic viscosity | 0.659 | 0.744 | 0.950 | 0.996 | 0.959 |
| | (dL/g) | | | | | |
| | melting point (° C.) | 115.7 | 108.5 | NA | 116.7 | 117.1 |
| | Tg (° C.) | 10.4 | 19.4 | 15.1 | 11.4 | 14.3 |
| | crystallinity (J/g) | 30.2 | 24.5 | NA | 31.0 | 30.1 |
| fiber before | fiber strength | 1.14 | 1.10 | NA | 1.34 | NA |
| stretching | (gf/den) | | | | | |
| | breaking elongation | 20.5 | 81.2 | NA | 145.1 | NA |
| | (%) | | | | | |
| fiber after | fiber strength | NA | 1.87 | NA | 2.31 | NA |
| stretching | breaking elongation | NA | 7.80 | NA | 19 | NA |
| | (%) | | | | | |

Accordingly, diols containing an appropriate ratio of suitable cyclic diol and 1,6-hexanediol could be reacted with aromatic diacid or diester (e.g. (a1) DMT and (a2) DMI or DmFDCA) to obtain a polyester fiber with high strength and low melting point.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A polyester, being:
formed by copolymerizing (a) diacid or diester and (b) diol, wherein (a) diacid or diester comprises (a1) 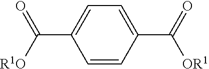
and (a2) 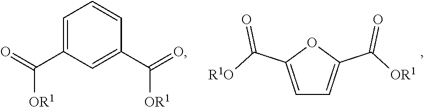
or a combination thereof, and each of R¹ is independently H or C₁₋₁₀ alkyl group,
wherein (b) diol comprises (b1) 1,6-hexanediol and (b2) 2,2,4,4-tetramethyl-1,3-cyclobutanediol, 1,4-cyclohexane dimethanol, tricyclo[5.2.1.0(2,6)]decanedimethanol, or a combination thereof,
and wherein (b1) and (b2) have a molar ratio (b1/b2) of 75:25 to 92:8.

2. The polyester as claimed in claim 1, wherein (a1) is 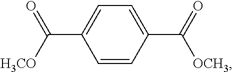 [SMILES: COC(=O)c1ccc(C(=O)OC)cc1]
(a2) is 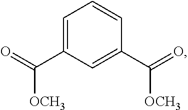 [SMILES: COC(=O)c1cccc(C(=O)OC)c1]
and (a1) and (a2) have a molar ratio (a1/a2) of 85:15 to 65:35.

3. The polyester as claimed in claim 1, wherein (a1) is 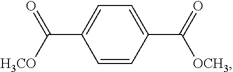 [SMILES: COC(=O)c1ccc(C(=O)OC)cc1]
(a2) is 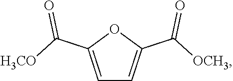 [SMILES: COC(=O)c1ccc(C(=O)OC)o1]
and (a1) and (a2) have a molar ratio (a1/a2) of 85:15 to 15:85.

4. The polyester as claimed in claim 1, wherein (b) diol is free of ethylene glycol.

5. The polyester as claimed in claim 1, having a melting point of 80° C. to 115° C.

6. The polyester as claimed in claim 1, having a glass transition temperature of 13° C. to 25° C.

7. The polyester as claimed in claim 1, having an intrinsic viscosity of greater than 0.85 dL/g and less than 1.20 dL/g.

8. A fiber, comprising the polyester as claimed in claim 1.

9. The fiber as claimed in claim 8, having a fiber strength of greater than 0.9 gf/den and less than 5.0 gf/den.

10. The fiber as claimed in claim 8, having a breaking elongation of greater than 10% and less than 200%.
